(19) United States
(12) Patent Application Publication
(10) Pub. No.: US 2015/0156788 A1
(43) Pub. Date: Jun. 4, 2015

(54) COMMUNICATION METHOD AND COMMUNICATION DEVICE USING OPEN-LOOP LINK IN WIRELESS LAN SYSTEM THAT SUPPORTS MULTI-BANDWIDTH

(71) Applicant: Electronics and Telecommunications Research Institute, Daejeon (KR)

(72) Inventors: Hee Jung Yu, Daejeon (KR); Min Ho Cheong, Daejeon (KR); Jae Seung Lee, Daejeon (KR); Hyoung Jin Kwon, Daejeon (KR); Sok Kyu Lee, Daejeon (KR)

(21) Appl. No.: 14/405,755

(22) PCT Filed: Jun. 13, 2013
(86) PCT No.: PCT/KR2013/005221

§ 371 Date: Dec. 4, 2014

(30) Foreign Application Priority Data
Jun. 13, 2012 (KR) 10-2012-0063151
May 2, 2013 (KR) 10-2013-0049523
Jun. 12, 2013 (KR) 10-2013-0067294

(51) Int. Cl. H04W 72/08

(52) U.S. Cl. CPC H04W 72/085; H04W 84/12

(57) ABSTRACT

A communication method and a communication apparatus using an open-loop link in a wireless local area network (WLAN) system supporting a multi-bandwidth are disclosed. A communication method using an open-loop link according to an exemplary embodiment includes a transmission apparatus of a WLAN system to support a multi-bandwidth, receiving link margin information on each of a plurality of bandwidths from a reception apparatus, acquiring a margin for a signal-to-noise ratio (SNR) based on the link margin information and determining a modulation and coding scheme (MCS) and a bandwidth for use based on the margin for the SNR, and transmitting data to the reception apparatus using the determined MCS and bandwidth.

### TECHNICAL FIELD

The present invention relates to a communication method and a communication apparatus using an open-loop link in a wireless local area network (WLAN) system supporting a multi-bandwidth.

### BACKGROUND ART

Wireless local area network (LAN) technology is advancing in three directions. First, a 60-GHz band and a 5-GHz band are used in a WLAN in order to enhance a transfer rate. Second, a frequency band of less than 1 GHz is used for a wideband wireless local area network (WLAN) uses to expand coverage thereof as compared with conventional WLAN technology. Third, a technique of reducing a link setup time of a WLAN system is adopted.

Generally, a receiving terminal notifies a transmitting terminal of information on a signal-to-noise ratio (SNR) or recommended transfer rate, and the transmitting terminal determines a transfer rate based on the feedback information. Such a closed-loop system using feedback information may determine an optimal transfer rate.

However, the closed-loop system involves transmitting and receiving frames to transmit feedback information all the time.

### DISCLOSURE OF INVENTION

### Technical Goals

An aspect of the present invention is to provide a communication method and a communication apparatus using an open-loop link, which transmit information of a receiving terminal for determining an optimal transfer rate, that is, a modulation scheme, code rate or bandwidth, in wireless communication supporting a multi-bandwidth and determines a transfer rate by a transmitting terminal using the information.

Further, an aspect of the present invention is to provide a communication method and a communication apparatus that enable a station to efficiently calculate a signal-to-interference plus noise ratio (SINR) of an uplink channel only based on downlink channel information using link margin information in frequency-selective transmission and to perform frequency-selective transmission.

### Technical Solutions

A communication method using an open-loop link according to an exemplary embodiment includes a transmission apparatus of a wireless local area network (WLAN) system to support a multi-bandwidth, receiving link margin information on each of a plurality of bandwidths from a reception apparatus, acquiring a margin for a signal-to-noise ratio (SNR) based on the link margin information and determining a modulation and coding scheme (MCS) and a bandwidth for use based on the margin for the SNR, and transmitting data to the reception apparatus using the determined MCS and bandwidth.

The link margin information may be a sum of a transmission power of the reception apparatus and a minimum receive sensitivity of the reception apparatus.

The margin for the SNR may be determined based on a transmission power of the transmission apparatus, the link margin information, and a received signal strength of the transmission apparatus.

The determining of the bandwidth for use may include comparing a margin for a first SNR of a first bandwidth with a margin for a second SNR of a second bandwidth and determining the first bandwidth as the bandwidth for use when a difference between the margins for the first SNR and the second SNR is greater than a preset value.

The bandwidth for use may be determined to be a bandwidth having a minimum margin for the SNR when the same MCS is applied to the plurality of bandwidths.

An information element for transmitting the link margin information may include ‘a first link margin for a first bandwidth’ and ‘a difference between the first link margin and a second link margin for a second bandwidth.’

A communication method using an open-loop link according to another exemplary embodiment includes a communication apparatus of a WLAN system receiving link margin information on each of a plurality of channels from an access point (AP), verifying channel status information on each of the plurality of channels based on packets received from the AP, and selecting one of the channels based on the link margin information and the channel status information.

The selecting of the channel may include determining a channel having a best channel characteristic based on ‘the channel status information’ and ‘interference information acquired from the link margin information.’

A frame for transmitting the link margin information may include an active channel activity bitmap, a field to indicate a maximum selectable bandwidth and fields to indicate link margins for active channels.

A communication apparatus of a WLAN system according to an exemplary embodiment includes a reception unit to receive link margin information on each of a plurality of bandwidths from a reception apparatus of the WLAN system supporting a multi-bandwidth, a controller to acquire a margin for an SNR based on the link margin information and determine an MCS and a bandwidth for use based on the margin for the SNR, and a transmission unit to transmit data to the reception apparatus using the determined MCS and bandwidth.

A communication apparatus of a WLAN system according to another exemplary embodiment includes a reception unit to receive link margin information on each of a plurality of channels from an AP of the WLAN system, a status information verification unit to verify channel status information on each of the plurality of channels based on packets received from the AP, and a channel selection unit to select any one of the channels based on the link margin information and the channel status information.

A communication method of a WLAN system according to an exemplary embodiment includes a communication apparatus to support multi-bandwidths, acquiring link margin information on a first bandwidth or link margin information on a first channel, acquiring link margin information on a second bandwidth or link margin information on a second channel, configuring ‘a first frame comprising the link margin information on the first bandwidth and the link margin information on the second bandwidth’ or ‘a second frame comprising the link margin information on the first channel and the link margin information on the second channel,’ and transmitting the first frame or the second frame to a terminal in a network.

### Advantageous Effects

As information of a receiving terminal for determining an optimal transfer rate, that is, a modulation scheme, code rate or bandwidth, in wireless communication supporting a multi-bandwidth is transmitted, a transmitting terminal may determines a transfer rate using the information.

Thus, according to an exemplary embodiment, efficiency in channel utilization may be enhanced.

Further, a station may efficiently calculate a signal-to-interference plus noise ratio (SINR) of an uplink channel only based on downlink channel information using link margin information in frequency-selective transmission and perform frequency-selective transmission.

### BRIEF DESCRIPTION OF DRAWINGS

FIG. 1 illustrates a multi-bandwidth of a wideband wireless local area network (WLAN) system.

FIG. 2 illustrates a communication method using an open-loop link according to an exemplary embodiment.

FIG. 3 illustrates relationship between link margin information on a single bandwidth and a minimum sensitivity.

FIG. 4 is a flowchart illustrating a communication method using an open-loop link conducted by a station according to an exemplary embodiment.

FIG. 5 illustrates relationship between a minimum sensitivity and link margin information by bandwidth of a WLAN system using a multi-bandwidth.

FIG. 6 illustrates a change in link margin by bandwidth due to a varying channel frequency response.

FIGS. 7A and 7B illustrate frames configured to transmit link margin information according to an exemplary embodiment.

FIG. 8 illustrates a packet structure used for a sounding process according to an exemplary embodiment.

FIG. 9 illustrates a frequency-selective transmission process according to an exemplary embodiment.

FIG. 10 illustrates a channel selection method according to an exemplary embodiment.

FIG. 11 illustrates a frame structure for transmitting link margin information by channel according to an exemplary embodiment.

FIG. 12 illustrates a communication apparatus of a WLAN system according to an exemplary embodiment.

FIGS. 13A and 13B illustrate a 2-MHz mode NDP packet structure and a 1-MHz mode NDP packet structure.

### BEST MODE FOR CARRYING OUT THE INVENTION

Hereinafter, exemplary embodiments of the present invention will be described in detail with reference to the accompanying drawings.

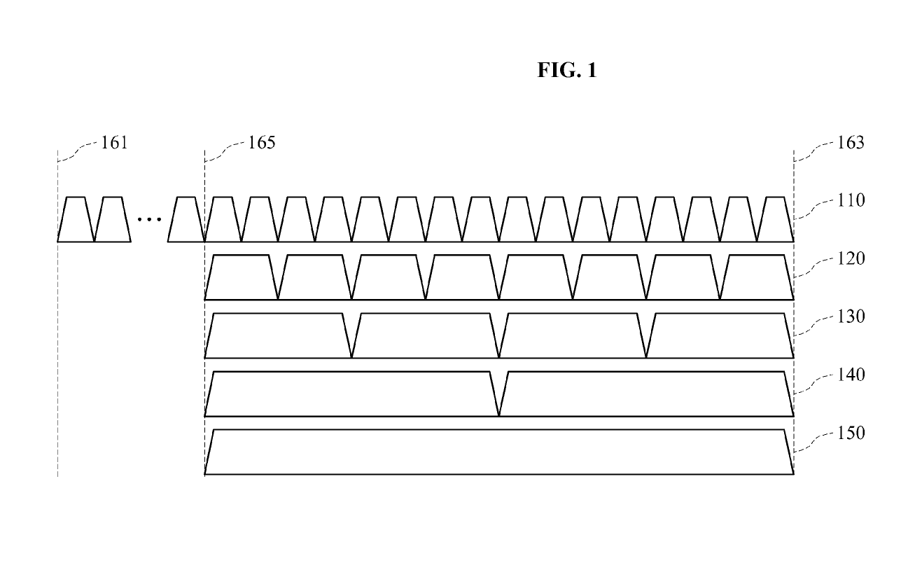

FIG. 1 illustrates a multi-bandwidth of a wideband wireless local area network (WLAN) system.

A wideband WLAN system, for example, a WLAN system defined in an IEEE 802.11ah standard, may support a multi-bandwidth. The multi-bandwidth may include a first bandwidth with a lowest signal-to-noise ratio (SNR) and a second bandwidth twice larger than the first bandwidth. Here, the first bandwidth may be 1 MHz.

Referring to FIG. 1, the multi-bandwidth may include a 1-MHz bandwidth 110, a 2-MHz bandwidth 120, a 4-MHz bandwidth 130, an 8-MHz bandwidth 140 and a 16-MHz bandwidth 150. The wideband WLAN system may have a frequency band of 1 GHz or less.

Thus, the multi-bandwidth may be expressed as including 1 MHz, 2 MHz, 4 MHz, 8 MHz and 16 MHz.

Thus, in FIG. 1, a lower frequency 161 may range from 700 to 920 MHz, and an upper frequency 163 may range from 750 to 930 MHz.

As shown in FIG. 1, the 1-MHz bandwidth 110 may be allocated in all channels, while the other bandwidths 120, 130, 140 and 150 may be allocated in only part of all channels.

For example, the 16-MHz bandwidth 150 may be allocated between a reference numeral 165 of FIG. 1 and the upper frequency 163. Referring to FIG. 1, the 2-MHz bandwidth 120 may be allocated eight channels, the 4-MHz bandwidth 130 may be allocated four channels, and the 8-MHz bandwidth 130 may be allocated two channels. However, channel allocation shown in FIG. 1 is provided for illustrative purposes only, and a number of channels and a frequency band may be configured in various methods.

A transmission mode using the 1-MHz bandwidth 110 may be defined as a 1-MHz mode, while a transmission mode using the 2-MHz bandwidth 120 may be defined as a 2-MHz mode.

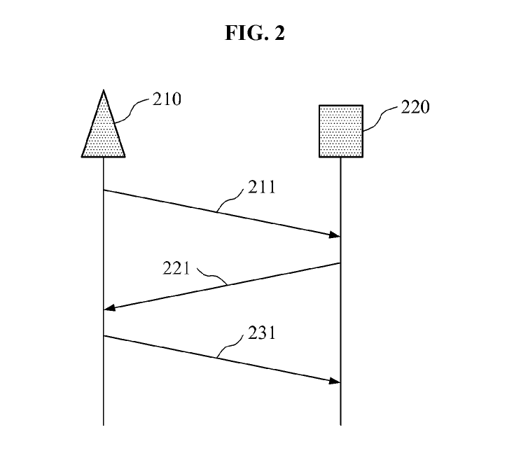

FIG. 2 illustrates a communication method using an open-loop link according to an exemplary embodiment.

It is one of crucial methods that a transmitter of a wireless communication system supporting a multi-bandwidth determines a transfer rate, that is, a modulation scheme, a code rate and a bandwidth for use, so as to enhance efficiency in channel utilization of the system. In transmission at a higher transfer rate than a capacity of a channel, a data packet error occurs, so that retransmission is involved. On the contrary, in transmission at a lower transfer rate, a channel is used inefficiently for a longer time to send the same data. Thus, it is crucial to transmit data at a highest transfer rate without occurrence of a data packet error.

To determine a transfer rate in view of channel capacity, a communication method using a closed-loop link may be used in which a receiver calculates an SNR of a channel to notify a transmitter of the SNR or reports a recommended transfer rate, for example, using a modulation and coding scheme (MCS), based on channel conditions.

The communication method using the closed-loop link may determine an accurate transfer rate under channel conditions, but involves updating this information based on channel conditions constantly changing with time.

To resolve such a disadvantage of the communication method using the closed-loop link, a parameter called link margin may be defined and reported to the transmitter.

Referring to FIG. 2, a reception apparatus 210 receiving data may calculate a link margin, and notify a transmission apparatus 220 transmitting data of the link margin in operation 211, while the transmission apparatus 220 may determine an MCS.

Subsequently, the transmission apparatus 220 may transmit data using the determined MCS in operation 221. The reception apparatus 210 may transmit an acknowledgement (ACK) after receiving the data and performing error checking in operation 231.

For example, the reception apparatus 210 may be an access point (AP) of a WLAN system, and the transmission apparatus 220 may be a terminal, for example, a station (STA) of the WLAN system.

Here, a measurement of a received signal of the STA 220 to a signal transmitted by the AP 210 may be defined by Equation 1.

RSSI_{STA}=P_{AP}_{—}_{TX}-31 Pₗₒₛₛ [Equation 1]

Here, RSSI_{STA}, P_{AP}_{—}_{TX}, and Pₗₒₛₛ denote a measurement of a received signal of the STA 220, a transmission power of the AP 210, and a pass loss by a channel, respectively.

An SNR margin (ΔSNR) that the AP 210 may receive at a higher transfer rate with respect to a minimum MCS may be defined by Equation 2.

$$\begin{matrix}Δ SNR = {P}_{STA \_ TX} - {P}_{loss} - {Min\_Sen}_{AP} \\ = {P}_{STA \_ TX} - ( {P}_{AP \_ TX} - {RSSI}_{STA} ) - {Min\_Sen}_{AP} \\ = {P}_{STA \_ TX} - ( {P}_{AP \_ TX} + {Min\_Sen}_{AP} ) + {RSSI}_{STA} \\ = {P}_{STA \_ TX} - LM + {RSSI}_{STA}\end{matrix} \qquad [ Equation 2 ]$$

Here, LM denotes a link margin, and P_{STA}_{—}_{TX} and Min_Sen_{AP} denote a transmission power of the STA 220 and a minimum receive sensitivity of the AP 210, respectively.

Referring to Equation 2, the link margin may be defined by Equation 3.

LM=P_{AP}_{—}_{TX}+Min_Sen_{AP} [Equation 3]

The STA 220 knows the transmission power P_{STA}_{TX} and RSSI_{STA} and thus may identify an SNR margin at the minimum receive sensitivity when link margin information is given.

The STA 220 may increase a transfer rate using an MCS high by the SNR margin.

Meanwhile, in a WLAN system supporting a multi-bandwidth, an interference level may vary by bandwidth and a measure of a received signal may change according to a frequency response of a channel.

Thus, the WLAN system supporting the multi-bandwidth may need to consider interference levels in each of a plurality of bandwidths or a frequency response of a channel.

In one embodiment, a transmission apparatus of the WLAN system supporting the multi-bandwidth receives link margin information on each of a plurality of bandwidths from a reception apparatus.

For example, in FIG. 2, the AP 210 may calculate link margin information on each of a plurality of bandwidths, and transmit the link margin information on each bandwidth to the STA 220 in operation 211.

The STA 220 may determine an MCS and a bandwidth for use based on the link margin information on each bandwidth.

The STA 220 may transmit data using the determined MCS and bandwidth in operation 221, and the AP 210 may transmit an ACK after receiving the data and performing error checking in operation 231.

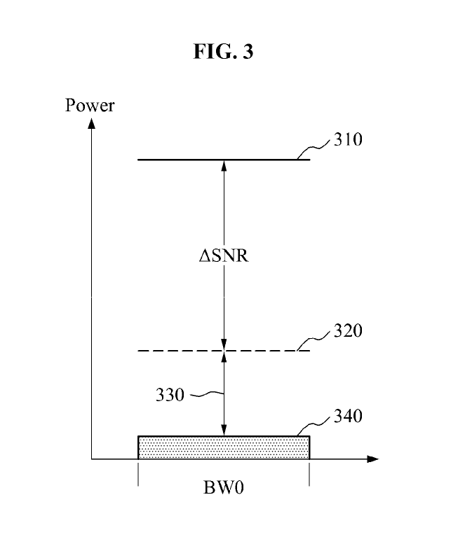

FIG. 3 illustrates relationship between link margin information on a single bandwidth and a minimum sensitivity.

Referring to FIG. 3, when a single bandwidth BW0 is used, an SNR margin ΔSNR receivable at a higher transfer rate with respect to a minimum MCS may be calculated based on relationships between a noise level 340, a minimum sensitivity level 320 and a received signal level 330 at an AP.

Here, the noise level 340 may be a level of a sum of noise and interference. A reference number 330 of FIG. 3 refers to an SNR needed to receive data using a lowest MCS.

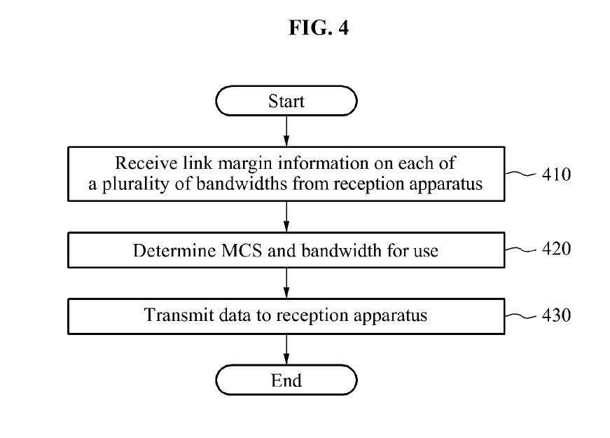

FIG. 4 is a flowchart illustrating a communication method using an open-loop link conducted by an STA according to an exemplary embodiment.

Referring to FIG. 4, in operation 410, the STA receives link margin information on each of a plurality of bandwidths from a reception apparatus. Here, the STA is a transmission apparatus of a WLAN system supporting a multi-bandwidth. Further, the reception apparatus may be an AP of the WLAN system.

Here, the link margin information may be a sum of a transmission power of the reception apparatus and a minimum receive sensitivity of the reception apparatus. The minimum receive sensitivity of the reception apparatus may vary depending on the bandwidths.

In operation 420, the STA acquires an SNR margin based on the link margin information and determines an MCS and a bandwidth for use based on the SNR margin.

Here, the SNR margin may be determined based on a transmission power of the transmission apparatus, the link margin information and information on a received signal strength of the transmission apparatus.

For example, the STA may select any one of two available bandwidths BW0 and BW1 and determine an MCS. Here, BW1 is broader than BW0. BW0 may be referred to as a sub-channel of BW1.

Here, suppose that a link margin for the bandwidth BW0 is smaller than a link margin for the bandwidth BW1, and thus ΔSNR0 of BW0 is greater than ΔSNR1 of BW1. Here, when different MCSs may not be applied to the respective bandwidths, for example, when the STA supports a single MCS only, the STA may choose BW1 with a lower SNR margin so as to prevent a data transmission error.

Thus, transmission may be conducted using a relatively low MCS despite use of a broad bandwidth.

Further, when the same MCS is used for the plurality of bandwidths, a bandwidth with a smallest SNR margin may be determined for use.

Alternatively, when ΔSNR0-ΔSNR1 is high, it is more proper for channel conditions to conduct transmission using a high MCS in accordance with ΔSNR0 utilizing BW0 only, instead of using a low MCS in accordance with ΔSNR1.

As such, an optimal MCS and a transmission bandwidth may be determined by various ways, in which a link margin calculated by bandwidth is needed.

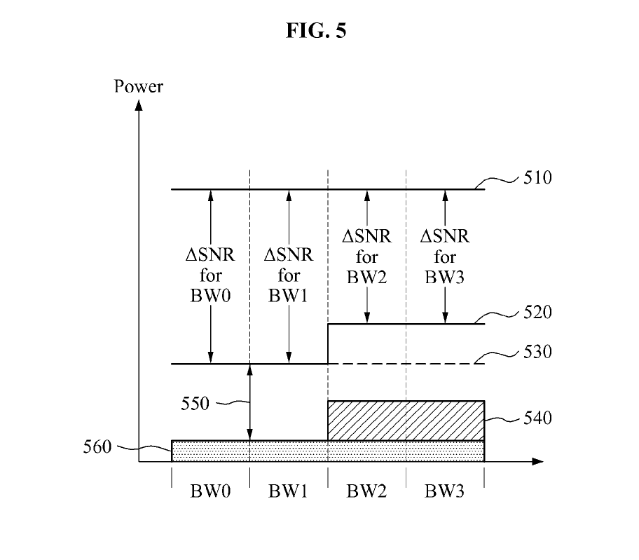

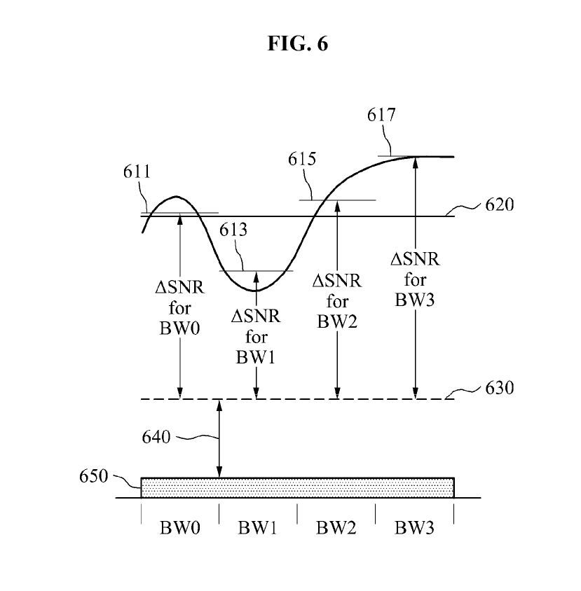

Conditions and reasons for a link margin varying by bandwidth will be described with reference to FIGS. 5 and 6.

In one embodiment, the determining of the bandwidth for use in operation 420 may include comparing a margin for a first SNR of a first bandwidth with a margin for a second SNR of a second bandwidth and determining the first bandwidth as the bandwidth for use when a difference between the margins for the first SNR and the second SNR is greater than a preset value.

In operation 430, the STA transmits data to the reception apparatus using the determined MCS and bandwidth.

FIG. 5 illustrates relationship between link margin information by bandwidth of a WLAN system using a multi-bandwidth and a minimum sensitivity.

There are two typical reasons that a link margin varies by bandwidth. First, an interference signal level varies in each band. Second, frequency responses of channels are different in a time division duplex (TDD) system. In addition to these two reasons, various reasons may exist.

For example, when a basic service set (BSS) using part of the same band is present around the AP or STA, so that an interference signal level may change by bandwidth.

Referring to FIG. 5, among four bandwidths BW0, BW1, BW2 and BW3, interference exists in two bandwidths BW2 and BW3, and a minimum receive sensitivity 520 of these two bandwidths in view of an interference level 540 may be higher than a minimum receive sensitivity 530 of the other bands.

Thus, link margins for BW2 and BW3 are greater than link margins for BW0 and BW1 by a level of an intensity signal.

In FIG. 5, a reference numeral 510 refers to a received signal strength of the STA, a reference numeral 540 refers to an SNR needed to receive a lowest MCS, and a reference 560 refers to a noise level.

FIG. 6 illustrates a change in link margin by bandwidth due to a varying channel frequency response.

Since a difference between frequency response levels determines a received signal strength, a difference between frequency response levels of bandwidths is directly linked with a difference between link margins.

Thus, as shown in FIG. 5, when different reception powers of the AP are set in consideration of average channel gains 611, 613, 615 and 617 in the respective bands, ASNRs in the respective bands may differ by differences between the average channel gains 611, 613, 615 and 617.

The AP may calculate link margins based on the differences between the average channel gains 611, 613, 615 and 617 according to Equation 2.

In FIG. 6, a curve represents a channel frequency response, a reference numeral 620 refers to a received signal strength of the STA, a reference number 630 refer to a minimum receive sensitivity, a reference numeral 640 refers to an SNR needed to receive a lowest MCS, and a reference 650 refers to a noise level.

Referring to FIG. 6, ΔSNR of BW1 with a lowest average gain of a channel frequency response is smallest, while ΔSNR of BW3 with a highest average gain of a channel frequency response is largest.

Meanwhile, although ΔSNR has been described as being calculated using average gains of channel frequency responses, various results of channel responses, for example, a minimum value and a variation, may be also used to calculate ΔSNR and a link margin.

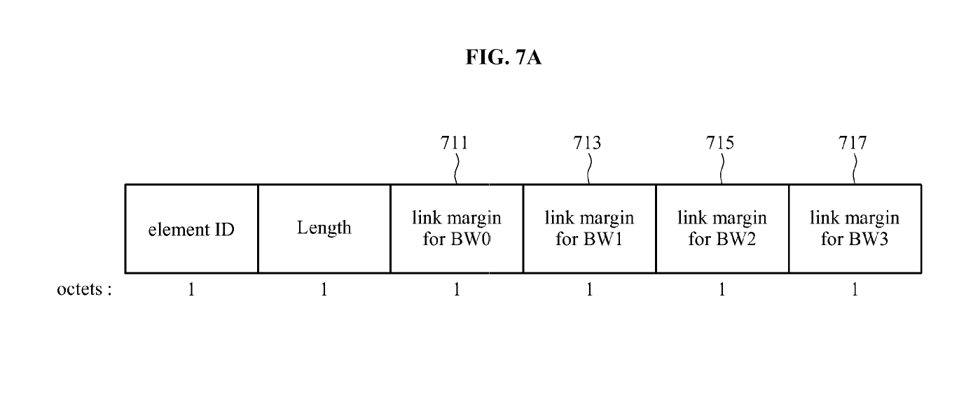

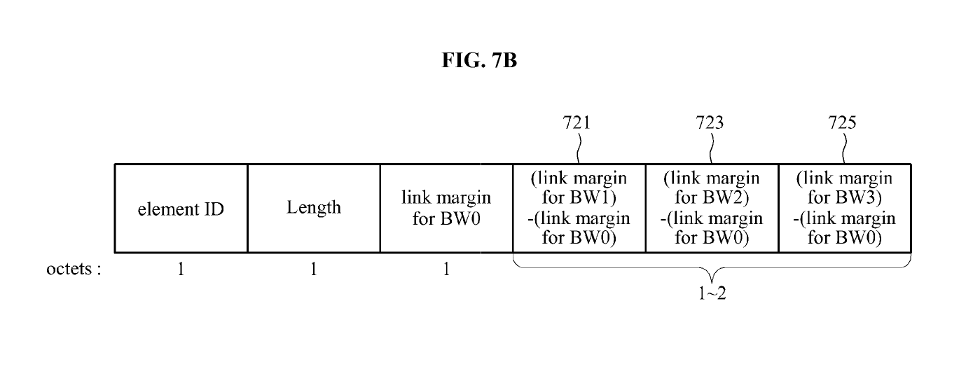

FIGS. 7A and 7B illustrate frames configured to transmit link margin information according to an exemplary embodiment.

Various methods may be adopted to transmit a link margin for each bandwidth to the STA. An easiest way is representing a link margin for each basic unit band with transmitting N bits.

Further, in transmitting link margins according to a related art, a link margin for one band basically used, such as a primary band, is represented with N bits and link margins for other bands are represented with as M bits which transmit only differences between the link margin for the one band and the link margins for the other bands.

FIGS. 7A and 7B illustrate frames configured to transmit link margin information in a form of information element. Here, the link margin information may be encoded by various methods based on characteristics of used bandwidths.

FIG. 7A illustrates transmitting a link margin by bandwidth using a 1-octet field. For example, a first field 711 may represent a link margin for a bandwidth BW0, and second to fourth fields 713, 715 and 717 may be fields for transmitting link margins for BW1, BW2 and BW3, respectively.

FIG. 7B illustrates a link margin for BW0 as a primary band represented in a 1-octet field, “link margin for BW0.”

For instance, a value obtained by subtracting the link margin for BW0 from the link margin for BW1 may be inserted into a field 721 for information on the link margin for BW1.

Regarding the link margins for BW1, BW2 and BW3, only differences between the link margin for BW0 and the link margins for BW1, BW2 and BW3 are transmitted in the respective fields 721, 723 and 725, thereby reducing total traffic.

For example, when a link margin difference is 5 bits, the fields 721, 723 and 735 are 15 bits. Thus, a total octet number may change based on a bit number representing a link margin difference.

Referring to FIGS. 7A and 7B, the information element for transmitting the link margin information may include ‘a first link margin for a first bandwidth’ and ‘a difference between the first link margin and a second link margin for a second bandwidth.’

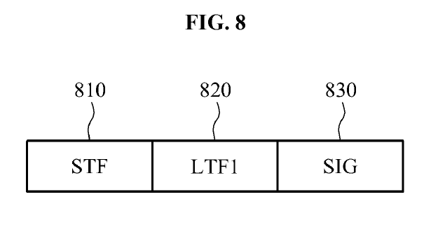

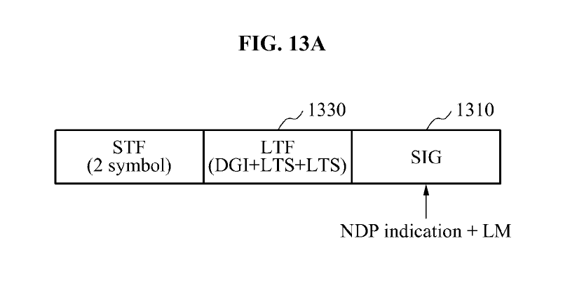

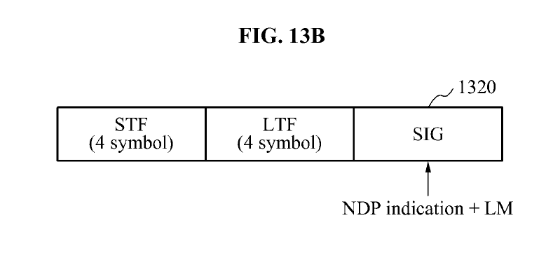

Meanwhile, the link margin information by band may be included in an SIG field of a null data packet (NDP) illustrated in FIGS. 8, 13A, and 13B.

FIG. 8 illustrates a packet structure used for a sounding process according to an exemplary embodiment.

A method of selecting a bandwidth using link margin information calculated by each of a plurality of bandwidths may be employed for frequency-selective transmission. For example, a particular sub-channel, channel and band may be selected using link margin information calculated by each of a plurality of frequency bands, channels, sub-channels and links.

For example, when the AP is a multi-bandwidth supporting device which is capable of using all four sub-channels BW0 to BW3 in transmission and reception but STAs are a narrow-band device which is able to use only part of BW0 to BW3, any one sub-channel or channel may be selected from the four bands.

Although selecting one of the four bands has been illustrated in the preceding example, the same concept may be applied to a case that two or three are selected from the four bands.

For frequency-selective transmission, the STA may need to know signal-to-interference plus noise ratios (SINRs) of sub-channels, that is, bands, and select a band with a highest SINR.

First, the STA involves a process of sounding a packet transmitted by the AP.

A sounding process for frequency-selective transmission in accordance with a related art includes reporting a start of the sounding process by the AP transmitting a no data packet announcement (NDPA) packet to report a start of the sounding process.

Next, the AP transmits a null data packet (NDP) including a short training field (STF) and a long training field (LTF) to estimate a channel and an SINR and a signal field having control information so that a receiver estimates the channel or SINR.

The NDPA packet is used to notify the STA of a start time of frequency-selective transmission or additional information. Thus, the NDPA packet may be replaced with a periodic frame, such as a beacon.

Referring to FIG. 8, the NDP packet may include an STF 810 for initial synchronization and signal detection, an LTF1 820 to represent a long training field for estimating a channel or SINR and an SIG 830 to represent control information on the NDP.

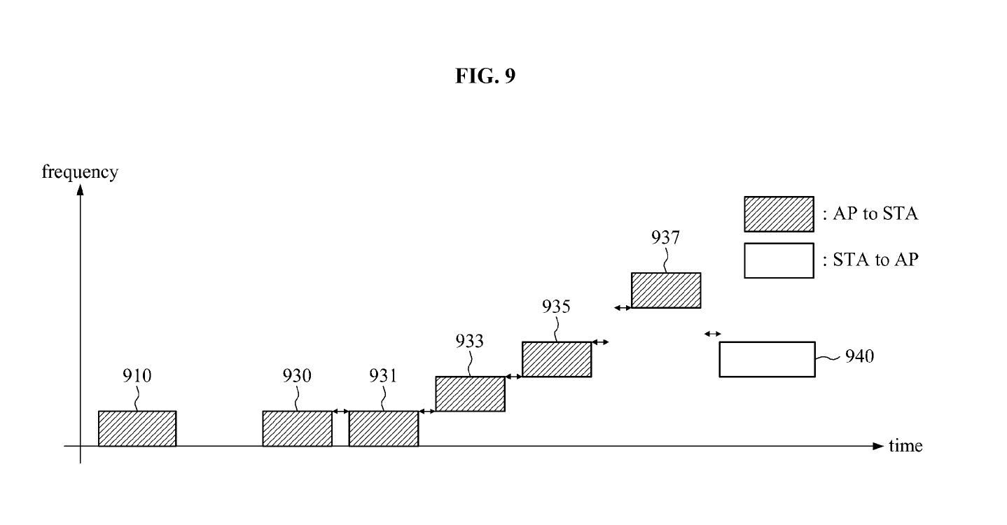

FIG. 9 illustrates a frequency-selective transmission process according to an exemplary embodiment.

Referring to FIG. 9, the AP may notify the STA of a start time of frequency-selective transmission through a beacon 910 or NDPA 930.

Next, a communication apparatus of the WLAN may receive link margin information on each of a plurality of channels from the AP. Here, the communication apparatus may be an STA.

Here, the link margin information on each of the channels may be transmitted through a plurality of NDPs 931, 933, 935 and 937 transmitted via different frequency bands at different times.

The communication apparatus, that is, the STA, verifies channel status information on each of the plurality of channels based on packets 931, 933, 935 and 937 received from the AP.

The communication apparatus verifies channel status information on each of the channels based on the packets received by frequency bands from the AP. Here, the communication apparatus may select any one channel to be used for data transmission among the channels based on the link margin information and the channel status information.

The communication apparatus may determine a channel with a best channel characteristic in consideration of ‘the channel status information’ and ‘interference information acquired from the link margin information’ in the selecting of the channel. Here, the channel status information may be an SNIR estimated by band.

The communication apparatus may also select a band with a highest value obtained by subtracting an interference level of the AP from the SNIR by band.

For example, the communication apparatus may estimate an SINR of each downlink based on the received packets, select a frequency band for use based on the estimated information and transmit a data packet 940 to the AP.

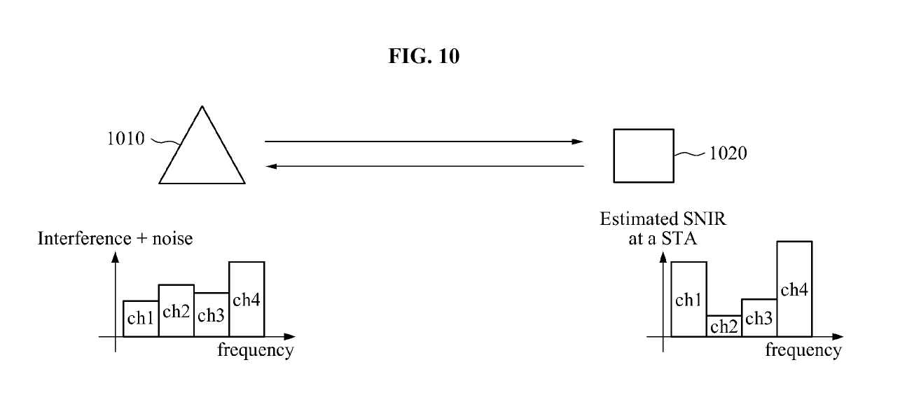

Various methods may be used to select a channel used for data transmission. Selecting a channel is illustrated in FIG. 10.

FIG. 10 illustrates a channel selection method according to an exemplary embodiment.

Referring to FIG. 10, an interference condition of an AP 1010 is the most favorable in ch1 but the least favorable in ch4. Further, an SNIR measured at an STA is highest in ch4 but lowest in ch2. Here, ch1, ch2, ch3 and ch4 refer to channel 1, channel 2, channel 3 and channel 4, respectively. Ch1, ch2, ch3 and ch4 may also refer to sub-channel 1, sub-channel 2, sub-channel 3 and sub-channel 4, respectively.

When a band is selected based on only a reception SINR, an STA 1020 may select ch4 based on an SINR level.

However, since ch4 has the least favorable interference condition, selecting ch1 may be more appropriate for uplink channel characteristics.

When a link margin value is used to report an interference condition of the AP 1010, the STA 1020 may analyze a relative interference level to effectively select an uplink channel.

As shown in FIG. 10, since interference conditions of bands in the AP 1010 are different from interference conditions of bands in the STA 1020, choosing a channel only based on a downlink SINR is not an optimal option. Thus, the AP 1010 transmits a link margin for each band to the STA 1020, which helps the STA 1020 to select a band.

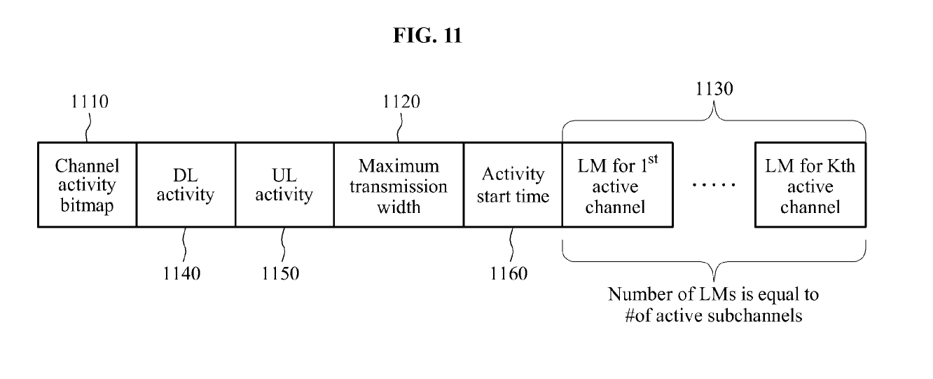

FIG. 11 illustrates a frame structure for transmitting link margin information by channel according to an exemplary embodiment.

Referring to FIG. 11, a frame for transmitting link margin information may include an active channel activity bitmap 1110, a field 1120, Maximum transmission width, to indicate a maximum selectable bandwidth and fields 1130, LM for Kth active channel, to indicate link margins for active channels.

As stated below LM for Kth active channel 1130 of FIG. 11, a number of LMs may be equal to a number of active sub-channels.

The frame for transmitting the link margin information may further include a field 1140, DL activity, to indicate an active channel of a downlink, a field 1150, UL activity, to indicate an active channel of an uplink, and a field 1160, an activity start time, to indicate a start time of frequency-selective transmission.

Activity start time 1160 may be, for example, a time at which the data 940 of FIG. 9 starts to be transmitted.

Meanwhile, the frame structure for transmitting the link margin information by channel may be defined as an information element form as shown in FIG. 7.

Further, the link margin information by channel may be transmitted, being inserted into the beacon 910 or NDPA 930 of FIG. 9.

In addition, the link margin information by channel may be inserted into SIG 830 of the NDP shown in FIG. 8. For example, link margin information on each of a plurality of channels may be transmitted through an NDP packet.

Meanwhile, an NDP packet used for the sounding process may be transmitted in the 2-MHz mode using a 2-MHz bandwidth. Here, in coverage of the AP, a packet transmitted in the 1-MHz mode may be received but a packet transmitted in a 1-MHz mode may not be received. The 1-MHz mode enables a signal to be transmitted to a farthest distance due to a low SNR.

Thus, the NDP packet used for the sounding process may need transmitting not only in the 2-MHz mode but in the 1-MHz mode. FIGS. 13A and 13B illustrate a 2-MHz mode NDP packet structure and a 1-MHz mode NDP packet structure.

Here, FIG. 13A illustrates the 2-MHz mode NDP packet structure, while FIG. 13B illustrates the 1-MHz mode NDP packet structure.

An SIG field 1310 of a 2-MHz mode NDP packet and an SIG field 1320 of a 1-MHz mode NDP packet may include an NDP indication as information to report an NDP packet for sounding and an LM as link margin information by band.

In FIG. 13A, an LTF 1330 may include a double guard interval (DGI) and a long training symbol (LTS).

Referring to FIGS. 2, 4 and 9, a communication method for sub-channel selection may include a communication apparatus to support multi-bandwidths, acquiring link margin information on a first bandwidth or link margin information on a first channel, acquiring link margin information on a second bandwidth or link margin information on a second channel, and configuring ‘a first frame including the link margin information on the first bandwidth and the link margin information on the second bandwidth’ or ‘a second frame including the link margin information on the first channel and the link margin information on the second channel.’

The communication method may further include the communication apparatus transmitting the first frame or the second frame to a terminal in a network.

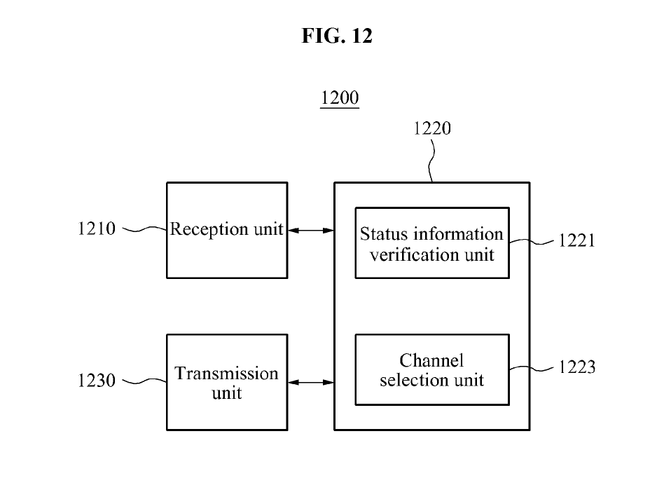

FIG. 12 illustrates a communication apparatus of a WLAN system according to an exemplary embodiment.

The apparatus shown in FIG. 12 may be a station.

The station 1200 includes a reception unit 1210, a controller 1220 and a transmission unit 1230.

The reception unit 1210 receives link margin information on each of a plurality of bandwidths from a reception apparatus of the WLAN system supporting a multi-bandwidth.

The reception unit 1210 may receive link margin information on each of a plurality of channels from an AP of the WLAN system.

The controller 1220 acquires a margin for an SNR based on the link margin information and determines an MCS and a bandwidth for use based on the margin for the SNR.

The controller 1220 may include a status information verification unit 1221 and a channel selection unit 1223.

The status information verification unit 1221 verifies channel status information on each of the plurality of channels based on packets received from the AP.

The channel selection unit 1223 selects any one of the channels based on the link margin information and the channel status information.

The transmission unit 1230 transmits data to the reception apparatus using the determined MCS and bandwidth.

The methods according to the exemplary embodiments may be recorded in computer-readable media as program instructions to be implemented by various computers. The media may also include, alone or in combination, the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy discs and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and higher level code that may be executed by a computer using an interpreter. The described hardware devices may be configured to act as one or more software modules in order to perform the operations of the above-described exemplary embodiments, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, other implementations, alternative embodiments and equivalents to the claimed subject matter are construed as being within the appended claims.

1. A communication method using an open-loop link comprising:
receiving, by a transmission apparatus of a wireless local area network (WLAN) system to support a multi-bandwidth, link margin information on each of a plurality of bandwidths from a reception apparatus;
acquiring a margin for a signal-to-noise ratio (SNR) based on the link margin information and determining a modulation and coding scheme (MCS) and a bandwidth for use based on the margin for the SNR; and
transmitting data to the reception apparatus using the determined MCS and bandwidth.

2. The communication method of claim 1, wherein the link margin information is a sum of a transmission power of the reception apparatus and a minimum receive sensitivity of the reception apparatus.

3. The communication method of claim 1, wherein the margin for the SNR is determined based on a transmission power of the transmission apparatus, the link margin information, and a received signal strength of the transmission apparatus.

4. The communication method of claim 1, wherein the determining of the bandwidth for use comprises comparing a margin for a first SNR of a first bandwidth with a margin for a second SNR of a second bandwidth and determining the first bandwidth as the bandwidth for use when a difference between the margins for the first SNR and the second SNR is greater than a preset value.

5. The communication method of claim 1, wherein the bandwidth for use is determined to be a bandwidth having a minimum margin for the SNR when the same MCS is applied to the plurality of bandwidths.

6. The communication method of claim 1, wherein an information element for transmitting the link margin information comprises ‘a first link margin for a first bandwidth’ and ‘a difference between the first link margin and a second link margin for a second bandwidth.’

7. The communication method of claim 1, wherein the link margin information on each of the plurality of bandwidths is transmitted through a null data packet (NDP).

8. A communication method using an open-loop link comprising:
a communication apparatus of a wireless local area network (WLAN) system receiving link margin information on each of a plurality of channels from an access point (AP);
verifying channel status information on each of the plurality of channels based on packets received from the AP; and
selecting one of the channels based on the link margin information and the channel status information.

9. The communication method of claim 8, wherein the selecting of the channel comprises determining a channel having a best channel characteristic based on ‘the channel status information’ and ‘interference information acquired from the link margin information.’

10. The communication method of claim 8, wherein a frame for transmitting the link margin information comprises an active channel activity bitmap, a field to indicate a maximum selectable bandwidth and fields to indicate link margins for active channels.

11. The communication method of claim 8, wherein the link margin information on each of the plurality of channels is transmitted through a null data packet (NDP).

12. A communication apparatus of a wireless local area network (WLAN) system, the communication apparatus comprising:
a reception unit to receive link margin information on each of a plurality of bandwidths from a reception apparatus of the WLAN system supporting a multi-bandwidth;
a controller to acquire a margin for a signal-to-noise ratio (SNR) based on the link margin information and determine a modulation and coding scheme (MCS) and a bandwidth for use based on the margin for the SNR; and
a transmission unit to transmit data to the reception apparatus using the determined MCS and bandwidth.

13. A communication apparatus of a wireless local area network (WLAN) system, the communication apparatus comprising:
a reception unit to receive link margin information on each of a plurality of channels from an access point (AP) of the WLAN system;
a status information verification unit to verify channel status information on each of the plurality of channels based on packets received from the AP; and
a channel selection unit to select one of the channels based on the link margin information and the channel status information.

14. A communication method of a wireless local area network (WLAN) system, the communication method comprising:
a communication apparatus to support multi-bandwidths, acquiring link margin information on a first bandwidth or link margin information on a first channel;
acquiring link margin information on a second bandwidth or link margin information on a second channel;
configuring ‘a first frame comprising the link margin information on the first bandwidth and the link margin information on the second bandwidth’ or ‘a second frame comprising the link margin information on the first channel and the link margin information on the second channel’; and
transmitting the first frame or the second frame to a terminal in a network.
